(19) United States
(12) Patent Application Publication
(10) Pub. No.: US 2025/0314775 A1
(43) Pub. Date: Oct. 9, 2025

(54) OBJECT DETECTION USING DENSE DEPTH AND LEARNED FUSION OF DATA OF CAMERA AND LIGHT DETECTION AND RANGING SENSORS

(71) Applicant: Torc Robotics, Inc., Blacksburg, VA (US)

(72) Inventors: Harish Karunakaran, Blacksburg, VA (US); Praveen Narayanan, Blacksburg, VA (US); Omid Hosseini Jafari, Blacksburg, VA (US); Fahim Mannan, Blacksburg, VA (US)

(21) Appl. No.: 18/627,159

(22) Filed: Apr. 4, 2024

(51) Int. Cl. G01S 17/894; G01S 7/481; G01S 17/86; G01S 17/93

(52) U.S. Cl. CPC G01S 17/894; G01S 7/4811; G01S 17/86; G01S 17/93

(57) ABSTRACT

A perception system is disclosed. The perception system includes at least one memory configured to store machine executable instructions, and at least one processor configured to execute the stored executable instructions to: (i) extract camera features from stereo images; (ii) extract LiDAR features from a LiDAR point cloud; (iii) transform the camera features in a bird's-eye-view (BEV) space; (iv) transform the LiDAR features in the BEV space; and (v) fuse the transformed camera features and LiDAR features in the BEV space using a learned fusion with attention technique to generate the fused camera features and LiDAR features in the BEV space.

### TECHNICAL FIELD

The field of the disclosure relates to fusion and modeling using a virtual driver, and in particular, to detect objects using camera features and light detection and ranging (LiDAR) sensor data using dense depth and learned fusion.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

Perception technologies generally uses sensors like a camera, a radio detection and ranging (RADAR) sensor, a light detection and ranging (LiDAR) sensor for detecting objects in the surrounding environment of the autonomous vehicle. Higher precision and recall in long range object detection tasks is required during automated driving of a truck and making behavioral decisions like lane changing or lane keeping due to high inertia of the truck. Accordingly, it is desirable to improve the precision and recall while performing long range object detection tasks.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, a perception system including at least one memory configured to store machine executable instructions, and at least one processor configured to execute the stored executable instructions is disclosed. The at least one processor is configured to: (i) extract camera features from stereo images; (ii) extract LiDAR features from a LiDAR point cloud; (iii) transform the camera features in a bird's-eye-view (BEV) space; (iv) transform the LiDAR features in the BEV space; and (v) fuse the transformed camera features and LiDAR features in the BEV space using a learned fusion with attention technique to generate the fused camera features and LiDAR features in the BEV space.

In another aspect, a vehicle including a stereo camera configured to capture stereo images, a light detection and ranging (LiDAR) sensor configured to generate data of a LiDAR point cloud, at least one memory configured to store machine executable instructions, and at least one processor configured to execute the stored executable instructions is disclosed. The at least one processor is configured to: (i) extract camera features from the stereo images; (ii) extract LiDAR features from the LiDAR point cloud; (iii) transform the camera features in a bird's-eye-view (BEV) space; (iv) transform the LiDAR features in the BEV space; and (v) fuse the transformed camera features and LiDAR features in the BEV space using a learned fusion with attention technique to generate the fused camera features and LiDAR features in the BEV space.

In yet another aspect, a method is disclosed. The method includes (i) extracting camera features from stereo images, the stereo images captured using a stereo camera; (ii) extracting light detection and ranging (LiDAR) features from a LiDAR point cloud, the LiDAR point cloud generated using data collected using a LiDAR sensor; (iii) transforming the camera features in a bird's-eye-view (BEV) space; (iv) transforming the LiDAR features in the BEV space; and (v) fusing the transformed camera features and LiDAR features in the BEV space using a learned fusion with attention technique to generate the fused camera features and LiDAR features in the BEV space.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic view of an autonomous truck;

FIG. 2 is a block diagram of the autonomous truck shown in FIG. 1;

FIG. 3 is a block diagram of an example computing system;

FIG. 4 illustrates a bird's-eye-view (BEV) pipeline of a perception system;

FIG. 5 illustrates a diagram showing fusion of camera features and LiDAR features in BEV space with attention;

FIG. 6 is an example pipeline for dense depth estimation of stereo images; and

FIG. 7 is a flow-chart of method operations performed by the BEV processing pipeline shown in FIG. 4.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

Three-Dimensional (3D) Space: The 3D Space is Physical Space in which a Physical Point is Represented Using Three Coordinates Along X-Axis, Y-Axis, and Z-Axis.

Bird's-eye-view (BEV) space: The BEV space corresponds with a physical space in which a physical point is represented as a view from a high angle as if seen by a bird in flight.

Camera space: The camera space represents objects in the environments relative to camera's position.

The disclosed systems and methods improve precision and recall of long range object detection tasks performed by an autonomy computing system or a perception and understanding module of the autonomy computing system. Various embodiments improve the precision and recall using dense depth to model the environment in the bird's-eye-view (BEV) space that allows the encoding of the camera features in three-dimensional (3D) space, which can then be fused with other modalities such as light detection and ranging (LiDAR) and radio detection and ranging (RADAR). This fused representation allows the additional semantics information from the cameras to be encoded, which cannot generally be done with other modalities. The fused representation thus enables better precision and recall on object detection tasks especially at a long range because of the longer field of view (FoV) of cameras in comparison with LiDAR and RADAR sensors. Additionally, the learned fusion may be used to combine features between camera and LiDAR sensor.

In some embodiments, dense depth or per pixel depth in the camera space enables projection of the camera image into a 3D representation in a BEV space. Extrinsic parameters of the camera image represent the location of the camera in the 3D space, and intrinsic parameters of the camera image represent an optical center and focal length of the camera set for the image. The extrinsic and intrinsic parameters of the camera may be used to determine the 3D location of each pixel in the 3D space and the 3D BEV in the camera space. The 3D BEV in the camera space may be then combined with the aggregated point cloud from the LiDAR sensor to train a transformer based neural network model to detect objects. By way of a non-limiting example, the objects for which the neural network may be trained to detect may include, lane lines in the environment of the autonomous vehicle. Because the point cloud from the LiDAR sensor is already in the BEV space, it generally requires minimal post processing before combination. Further, the dense depth may be obtained using the neural network trained for stereo depth estimation. Accordingly, fusion of features of LiDAR and camera sensors based on learned alignment, through attention, improves feature association in comparison with just concatenating the features of LiDAR and camera sensors because the features of LiDAR and camera sensors are fused based on their relevance or score of these features.

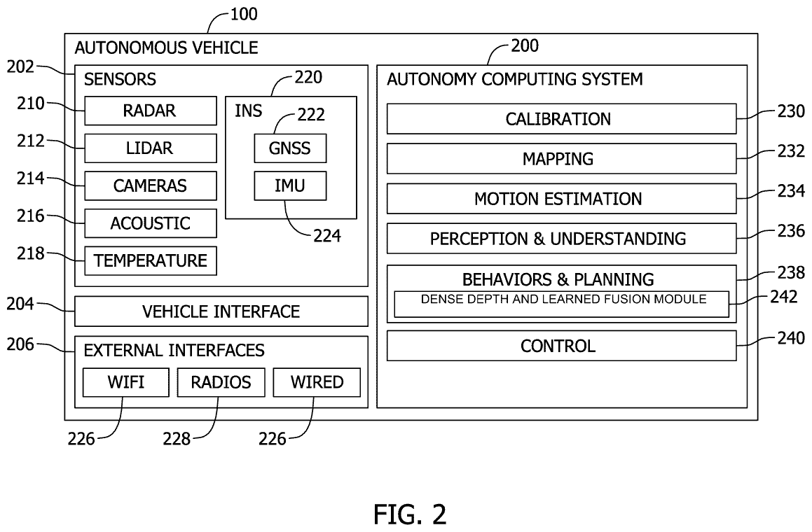

In some embodiments, fusion of features between LiDAR and camera sensors may be performed by a BEV processing pipeline embodied, for example, in an autonomy computing system shown in FIG. 2, that takes as input images from multiple cameras with per pixel dense depth. Additionally, data from multiple LiDAR sensors may also be used as input. By way of a non-limiting example, the BEV processing pipeline, embodied, for example, in an autonomy computing system, may employ a modified encoder-decoder configured for multi-task learning, with configurable task heads (e.g., a component of layer of the neural network) configured to perform a specific task, for example, and without limitation, a lane-line segmentation task, a 3D-object detection task, a semantic segmentation task, or multiple objects tracking and planning tasks.

In the modified BEV processing pipeline, features of the images may be encoded using a feature encoder (e.g., a residual neural network (ResNet)). The features are then projected to a 3D point cloud using dense depth as described in detail below. The dense camera 3D points are then ‘arranged or aligned to the BEV grid to generate BEV features. The BEV features are then decoded by the task heads, for example, for lane line segmentation or for 3D object detection task heads, to make their respective predictions.

Conventional algorithms used for BEV use sparse depth LiDAR sensor data or a mapping between two different planar projections of a camera image data (generally known as homography). However, sparse depth LiDAR sensor data or homography is not as accurate as dense depth produced from images captured using stereo cameras and processed through neural networks. Accordingly, using dense depth may improve precision and recall for the tasks such as, lane line detection or lane line segmentation. Further, conventional techniques for fusion of LiDAR sensor data and camera sensor data are based on concatenation features that may lead to misalignment. However, in some embodiments, fusion of LiDAR sensor data and camera sensor data is performed in a learned way through attention, as described in detail below. Fusion of LiDAR sensor data and camera sensor data in a learned way through attention improves alignment and solves the problem of misalignment when fusion is performed without attention. In particular, fusion in a learned way through attention is performed using text annotations.

Traditionally, in systems in which camera images are projected to 3D space using depth information learned from 3D bounding box supervised machine-learning algorithm, the depth information is generally sparse and scales with the number of 3D box annotations in a particular scene captured using the camera sensor. Because 3D bounding box supervision scaled with the number of 3D box annotations, using supervised machine-learning algorithm may require a large amount of data and annotations. However, per pixel depth annotations may provide much more plentiful supervision and help the neural network learn with far less data, and, thereby, ease annotation overhead. Further, LiDAR sensor data may be used to improve range measurements but suffers from sparsity for data corresponding to objects farther from the LiDAR sensor, is prone to weather effects, particularly poor performance in rain or snow. These problems, including the problems of sparsity in LiDAR sensor data, may be solved, as described herein, using dense depth providing the benefits of superior semantics of the camera with the added benefit of improved range measurements. Using the dense depth, a pseudo LiDAR point cloud may be created enabling fusion of the camera sensor data with the LiDAR sensor data.

In some embodiments, fusion of the camera sensor data with the LiDAR sensor data may be performed using a neural network including encoder and decoder stacks configured or adapted to perform prediction tasks described herein in the BEV space. Camera images from multiple cameras and point clouds of multiple LiDAR sensors may be taken as inputs to encoder stacks for transforming features of the camera images and point clouds into high dimensional features. For example, camera features may be projected in 3D space with dense depth, and intrinsic parameters and extrinsic parameters of camera may be used to generate a 3D point cloud of camera features for each camera sensor. Features corresponding to each camera sensor may be aggregated and splatted onto a BEV grid, for example, to generate 2.5 dimensional (2.5D) representation of camera features. A 3D encoder stack, such as voxelnet, may be used to inflate a 3D point cloud of a LiDAR sensor to high dimensional features. The inflated 3D point clouds of multiple LiDAR sensors may be aggregated, voxelized, and splatted to BEV grid features. In the next step, available BEV features of camera and LiDAR sensors may be combined to create a fused representation. The fused representation may be used as input to a decoder stack configured or adapted to generate the bounding boxes. In some embodiments, and by way of a non-limiting example, the fused representation with attention in BEV provides significant improvement because of more accurate depth estimation over the currently known state-of-the-art systems or methods. Additionally, accurate depth estimation according to embodiments described herein may be achieved using relatively fewer or cheaper computing resources.

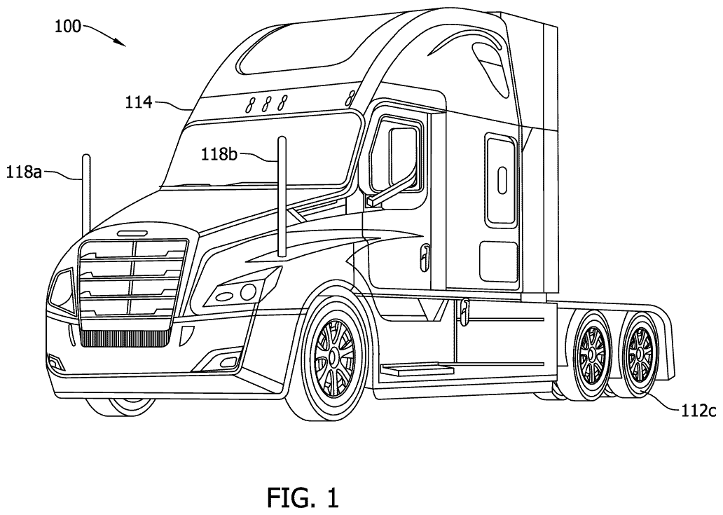

Various embodiments in the present disclosure are described with reference to FIGS. 1-4 below. Further, even though the embodiments are described for perception technologies used in autonomous vehicles, the embodiments described herein do not limit their scope to autonomous vehicles only and may be embodied in non-autonomous vehicles or semi-autonomous vehicles as well.

FIG. 1 illustrates a vehicle 100, such as a truck that may be conventionally connected to a single or tandem trailer to transport the trailers (not shown) to a desired location. The vehicle 100 includes a cabin 114 that can be supported by, and steered in the required direction, by front wheels 112a, 112b, and rear wheels 112c that are partially shown in FIG. 1. Wheels 112a, 112b are positioned by a steering system that includes a steering wheel and a steering column (not shown in FIG. 1). The steering wheel and the steering column may be located in the interior of cabin 114.

The vehicle 100 may be an autonomous vehicle, in which case the vehicle 100 may omit the steering wheel and the steering column to steer the vehicle 100. Rather, the vehicle 100 may be operated by an autonomy computing system (shown in FIG. 2) of the vehicle 100 based on data collected by a sensor network (not shown in FIG. 1) including one or more camera sensors, one or more RADAR sensors, one or more LiDAR sensors, etc.

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 120 for lane segment detection or lane marking detection, or objection detection in the environment of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras’ FOVs, which may be used to, for example, generate a bird's-eye-view of the environment surrounding autonomous vehicle 100.

In some embodiments, cameras 214 may be stereo cameras to produce stereo images. Data of the stereo cameras 214 may be sent to autonomy computing system 200 or other aspects of autonomous vehicle 100 for stereo depth estimation. The stereo depth estimation may be used for computing disparity d for each pixel in the reference image. Disparity refers to the horizontal displacement between a pair of corresponding pixels on the left and right images of the stereo cameras 214. For the pixel (x, y) in the left image, if its corresponding point is found at (x-d, y) in the right image, then the depth of this pixel may be calculated by f*B/d, where f corresponds with a focal length of the camera, B corresponds with a baseline, and d corresponds with the distance between two camera centers of the stereo cameras 214.

Accordingly, stereo depth estimation requires identifying corresponding points in the left and right images based on matching cost and post-processing. By way of a non-limiting example, for a given a rectified pair of images, the stereo depth estimation may be performed by dense depth and learned fusion model 242, which computes multiscale descriptors for each image of the rectified pair of images with a pyramid encoder. The multiscale descriptors are then used to construct 4D feature volumes at each scale, by taking the difference of potentially matching features extracted from epipolar scanlines. Each feature volume may be decoded or filtered with 3D convolutions, making use of striding along the disparity dimensions to minimize the required memory resources. The decoded output may be used to predict 3D cost volumes that generates on-demand disparity estimates for the given scale and then upsampled to combine with the next feature volume in the pyramid. Additionally, or alternatively, in some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. Radar sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused, as described herein, by dense depth and learned fusion model 242 to determine conditions (e.g., lane segmentation, lane marking detection, detection of other objects and their locations) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands or data to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and the dense depth and learned fusion module 242.

The dense depth and learned fusion module 242, for example, may be embodied within another module, such as behaviors and planning module 238, or separately. Alternatively, the dense depth and learned fusion module 242 may be embodied within the perception and understanding module 236. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100. The dense depth and learned fusion module 242 improves precision and recall in long range object detection tasks, such as lane line detection to assist in making behavioral decisions such as lane keeping and lane changing to allow for a smooth ride experience as well as to ensure load integrity by not performing aggressive maneuvers.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

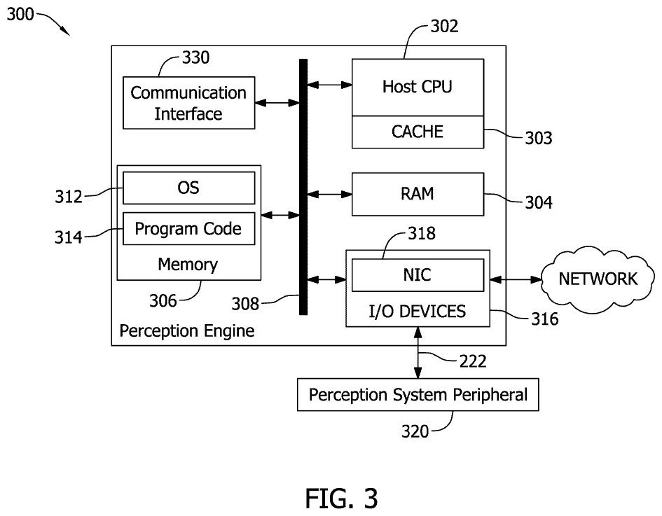

FIG. 3 is a block diagram of an example computing system 300, such as the autonomy computing system 200 shown in FIG. 2, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 2. In alternative embodiments, one or more section of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

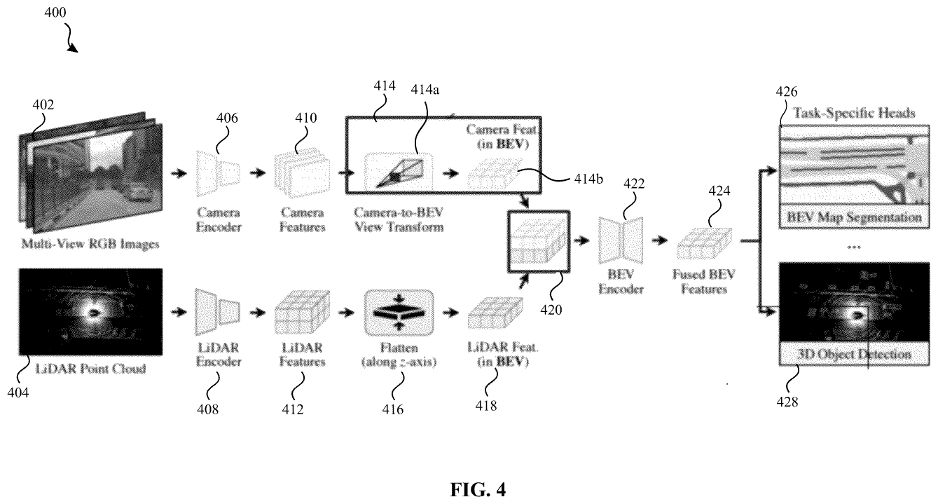

FIG. 4 illustrates a BEV processing pipeline 400 of a perception system for fusion of features of LiDAR and camera sensors based on learned alignment, through attention. In some embodiments, and by way of a non-limiting example, the BEV processing pipeline 400 may be implemented using a neural network. The BEV processing pipelined 400 may be implemented, for example, by the autonomy computing system 200 shown in FIG. 2. As described herein, the BEV processing pipeline 400 receives camera images 402 and LiDAR point cloud 404 as input for processing and generating fused representation 424 of BEV features. The fused representation 424 of BEV features are provided as input to task specific heads including, but not limited to, lane segmentation or lane marking detection head 426 or 3D object detection head 428. The fused representation 424 improves precision and recall of the lane segmentation or lane marking detection 426 or 3D object detection 428 using dense depth to model the environment of the vehicle 100 in BEV space. The camera images 402 may be, for example, stereo camera images captured using stereo cameras 214.

The BEV processing pipeline 400 includes a camera encoder stack 406 that is configured to receive the camera images 402 as input to produce camera features 410 as output. The camera images 402 may be, for example, multi-view red, green, blue (RGB) images of stereo cameras 214. In some embodiments, and by way of a non-limiting example, the camera encoder stack 406 is a series of convolutional layers that extract different levels of features from the input images. The camera encoder stack 406 produces camera features 410 as a feature map indicating specific patterns or structures in the image. As described herein, camera-to-BEV transform module 414 uses per pixel depth 414a in the camera space to project the camera image into a 3D representation 414b in BEV space, wherein the camera corresponds with a bird in flight. Per pixel depth 414a in the camera space may also be referenced as dense depth in the present disclosure. Additionally, or alternatively, the intrinsic parameters and extrinsic parameters of the camera may be used to determine the 3D location of each pixel in the BEV space.

The BEV processing pipeline 400 includes a LiDAR encoder stack 408 configured to receive the LiDAR point cloud 404 as input to produce LiDAR features 412 as output. In some embodiments, and by way of a non-limiting example, the LiDAR encoder stack 408 is a series of convolutional layers that extract semantic information of the LiDAR point cloud 404 at different levels as local features. The local features are then combined with global features. The global features may be highly abstracted local features. The aggregated local features and global features of the LiDAR point cloud are represented in FIG. 4 as LiDAR features 412. The LiDAR features 412 are flattened 416, along the Z-axis because the LiDAR features have high granularity along the Z-axis, in the 3D space to produce LiDAR features in BEV space 418.

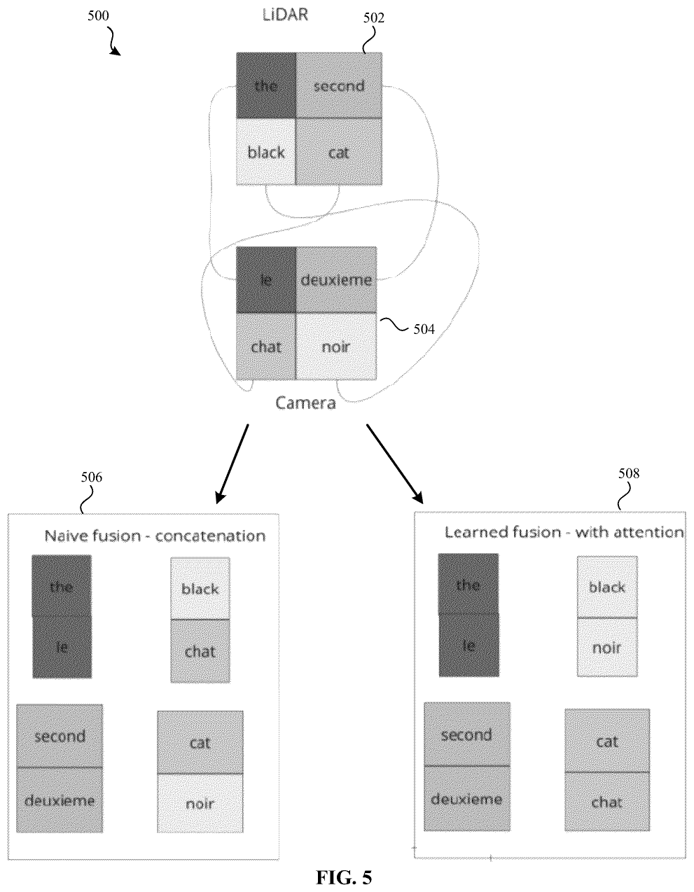

LiDAR features in BEV space 418 and camera features in BEV space 414b are combined together shown in FIG. 4 as 420. A BEV encoder 422 receives the combined LiDAR and camera features in BEV space 420 as input to generate fused BEV features 424, as shown in detail in FIG. 5. Fused BEV features 424 may be provided as inputs to various task-specific heads including, but not limited to, BEV map segmentation task head 426 or 3D object detection task head 428.

FIG. 5 illustrates a diagram 500 showing fusion of camera features and LiDAR features in BEV space with attention. By way of a non-limiting example, a LiDAR point cloud 502 in BEV space may include four features “the,” “second,” “black,” and “cat,” and camera features 504 in BEV space may include for features “le,” “deuxieme,” “chat,” and “noir.” As shown in FIG. 5, when the camera features 504 and LiDAR features 502 in BEV space are fused by concatenation (and without attention), the features of the LiDAR point cloud may be mapped or associated with camera features as shown in FIG. 5 as 506. A person skilled in the art may recognize fusion of the camera features and LiDAR features in BEV space by concatenation (and without attention) may cause incorrect mapping or association of the features. However, when the camera features 504 and LiDAR features 502 in BEV space are fused using learned fusion (with attention), the features of the LiDAR point cloud are mapped to, or associated with, camera features as shown in FIG. 5 as 508. Accordingly, fusion of the camera features and LiDAR features in BEV space using learned fusion (with attention) improves accuracy while mapping or associating camera features with LiDAR features.

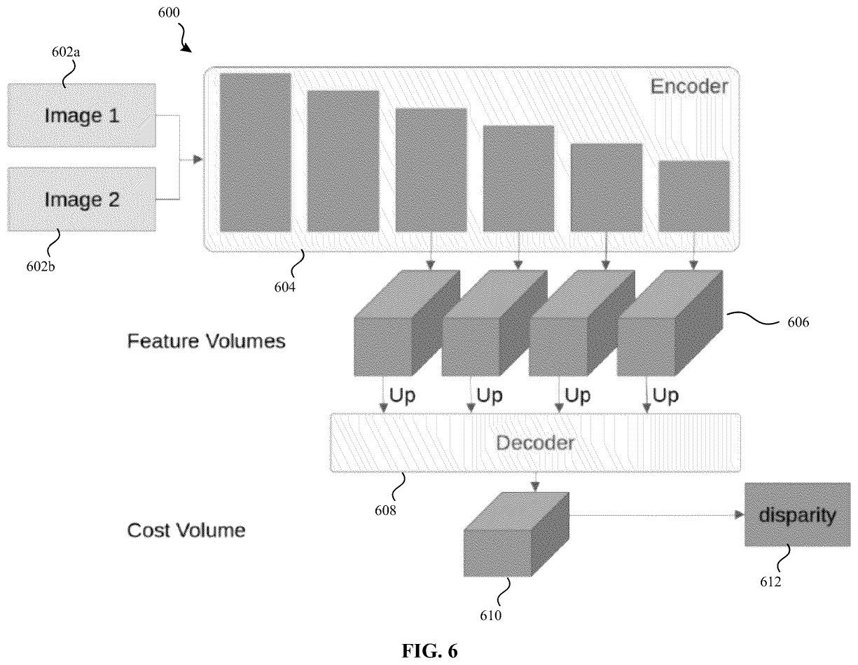

FIG. 6 is an example pipeline 600 for dense depth estimation of stereo images 602a and 602b captured using stereo cameras 214. The stereo depth estimation may be used for computing disparity d for each pixel in the reference image. Disparity refers to the horizontal displacement between a pair of corresponding pixels on the left and right images 602a 602b of the stereo cameras 214. For the pixel (x, y) in the left image 602a, if its corresponding point is found at (x-d, y) in the right image 602b, then the depth of this pixel may be calculated by f*B/d, where f corresponds with a focal length of the camera, B corresponds with a baseline or the distance between two camera centers of the stereo cameras 214, and the disparity d.

Accordingly, stereo depth estimation requires identifying corresponding points in the left and right images based on matching cost and post-processing by an encoder 604. By way of a non-limiting example, for a given a rectified pair of images, the stereo depth estimation may be performed by dense depth and learned fusion model 242, which computes multiscale descriptors for each image of the rectified pair of images with a pyramid encoder 604. The multiscale descriptors 606 are then used to construct 4D feature volumes at each scale, by taking the difference of potentially matching features extracted from epipolar scanlines. Each feature volume 606 is decoded, or filtered, with 3D convolutions by a decoder 608, making use of striding along the disparity dimensions to minimize the required memory resources. The decoded output is used to predict 3D cost volumes 610 that generate on-demand disparity estimates 612 for the given scale. In some embodiments, each feature volume 606 is upsampled to combine with the next feature volume in the pyramid.

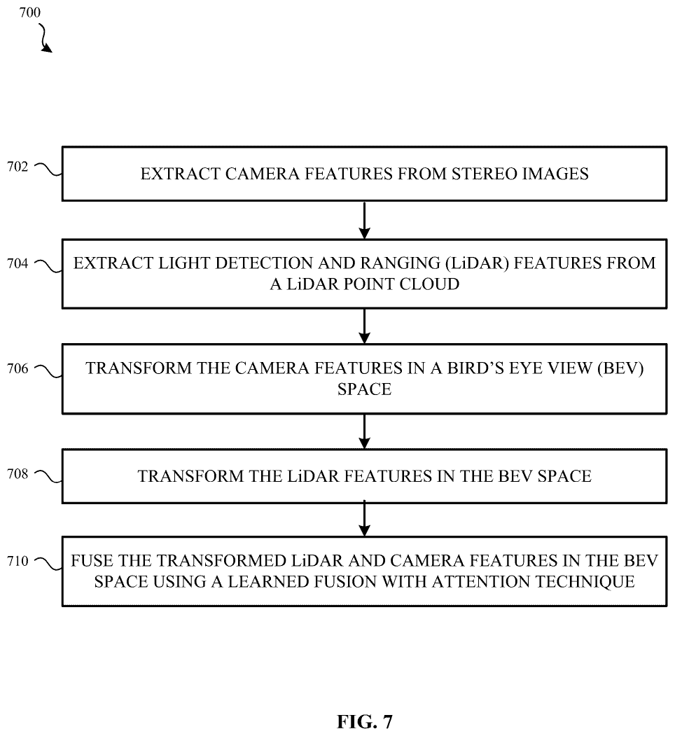

FIG. 7 is an example flow-chart 700 of method operations performed by the autonomy computing system 200 shown in FIG. 2 or the BEV processing pipeline 400 shown in FIG. 4. The method operations include extracting 702 camera features from stereo images. The stereo images are captured using a stereo camera mounted on the vehicle 100. The method operations include extracting 704 LiDAR features from a LiDAR point cloud. The LiDAR point cloud is generated using data collected using a LiDAR sensor mounted on the vehicle 100. The method operations include transforming 706 the camera features in a BEV space and transforming 708 the LiDAR features in the BEV space before fusing 710 the transformed camera features and LiDAR features in the BEV space using a learned fusion with attention technique to generate the fused camera features and LiDAR features in the BEV space. The fused camera features and LiDAR features in the BEV space are decoded for various tasks including, but not limited to, lane line segmentation, lane marking detection, or three-dimensional object detection tasks.

In some embodiments, the camera features from the stereo images are extracted using a camera encoder stack including a series of convolutional layers configured to extract different levels of features from the stereo images, and the LiDAR features from the LiDAR point cloud are extracted using a LiDAR encoder stack including a series of convolutional layers configured to extract semantic information of the LiDAR point cloud.

In some embodiments, the camera features are transferred in the BEV space using dense depth or per pixel depth in the stereo images to project the stereo images into a three-dimensional (3D) representation in the BEV space. The dense depth or per pixel depth in the stereo images is determined based upon at least a focal length of the stereo cameras, a baseline corresponding to a distance between two lenses of the stereo cameras, and a disparity corresponding to a horizontal displacement between a pair of corresponding pixels on the stereo images. LiDAR features are transformed in the BEV space by flattening the LiDAR features along an axis (e.g., along Z-axis) in which the LiDAR features have higher granularity in comparison to LiDAR features along other axes.

An example technical effect of the methods, systems, and apparatus described herein includes at least one of: (a) improvised ego-lane level localization corresponding to identifying the vehicle's position in a driving lane; and (b) achieving a true end-to-end redundant perception system including an object detection module, and one or more sensors.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A perception system, comprising:
at least one memory configured to store machine executable instructions; and
at least one processor configured to execute the stored executable instructions to:
extract camera features from stereo images;
extract LiDAR features from a LiDAR point cloud;
transform the camera features in a bird's-eye-view (BEV) space;
transform the LiDAR features in the BEV space; and
fuse the transformed camera features and LiDAR features in the BEV space using a learned fusion with attention technique to generate the fused camera features and LiDAR features in the BEV space.

2. The perception system of claim 1, wherein to transform the camera features in the BEV space, the at least one processor is further configured to use dense depth or per pixel depth in the stereo images to project the stereo images into a three-dimensional (3D) representation in the BEV space.

3. The perception system of claim 1, wherein the dense depth or per pixel depth in the stereo images is determined based upon at least a focal length of the stereo cameras, a baseline corresponding to a distance between two lenses of the stereo cameras, and a disparity corresponding to a horizontal displacement between a pair of corresponding pixels on the stereo images.

4. The perception system of claim 1, wherein to transform the LiDAR features in the BEV space, the at least one processor is further configured to flatten the LiDAR features along an axis in which the LiDAR features have higher granularity in comparison to LiDAR features along other axes.

5. The perception system of claim 1, wherein the camera features are extracted from the stereo images using a camera encoder stack including a series of convolutional layers configured to extract different levels of features from the stereo images.

6. The perception system of claim 1, wherein the LiDAR features are extracted from the LiDAR point cloud using a LiDAR encoder stack including a series of convolutional layers configured to extract semantic information of the LiDAR point cloud.

7. The perception system of claim 1, wherein the at least one processor is further configured to decode the fused camera features and LiDAR features in the BEV space for lane line segmentation, lane marking detection, or three-dimensional object detection.

8. A vehicle, comprising:
a stereo camera configured to capture stereo images;
a light detection and ranging (LiDAR) sensor configured to generate data of a LiDAR point cloud;
at least one memory configured to store machine executable instructions; and
at least one processor configured to execute the stored executable instructions to:
extract camera features from the stereo images;
extract LiDAR features from the LiDAR point cloud;
transform the camera features in a bird's-eye-view (BEV) space;
transform the LiDAR features in the BEV space; and
fuse the transformed camera features and LiDAR features in the BEV space using a learned fusion with attention technique to generate the fused camera features and LiDAR features in the BEV space.

9. The vehicle of claim 8, wherein to transform the camera features in the BEV space, the at least one processor is further configured to use dense depth or per pixel depth in the stereo images to project the stereo images into a three-dimensional (3D) representation in the BEV space.

10. The vehicle of claim 8, wherein the dense depth or per pixel depth in the stereo images is determined based upon at least a focal length of the stereo cameras, a baseline corresponding to a distance between two lenses of the stereo cameras, and a disparity corresponding to a horizontal displacement between a pair of corresponding pixels on the stereo images.

11. The vehicle of claim 8, wherein to transform the LiDAR features in the BEV space, the at least one processor is further configured to flatten the LiDAR features along an axis in which the LiDAR features have higher granularity in comparison to LiDAR features along other axes.

12. The vehicle of claim 8, wherein the camera features are extracted from the stereo images using a camera encoder stack including a series of convolutional layers configured to extract different levels of features from the stereo images.

13. The vehicle of claim 8, wherein the LiDAR features are extracted from the LiDAR point cloud using a LiDAR encoder stack including a series of convolutional layers configured to extract semantic information of the LiDAR point cloud.

14. The vehicle of claim 8, wherein the at least one processor is further configured to decode the fused camera features and LiDAR features in the BEV space for lane line segmentation, lane marking detection, or three-dimensional object detection.

15. A method, comprising:
extracting camera features from stereo images, the stereo images captured using a stereo camera;
extracting light detection and ranging (LiDAR) features from a LiDAR point cloud, the LiDAR point cloud generated using data collected using a LiDAR sensor;
transforming the camera features in a bird's-eye-view (BEV) space;
transforming the LiDAR features in the BEV space; and
fusing the transformed camera features and LiDAR features in the BEV space using a learned fusion with attention technique to generate the fused camera features and LiDAR features in the BEV space.

16. The method of claim 15, wherein the transforming the camera features in the BEV space comprises using dense depth or per pixel depth in the stereo images to project the stereo images into a three-dimensional (3D) representation in the BEV space.

17. The method of claim 15, further comprising determining the dense depth or per pixel depth in the stereo images based upon at least a focal length of the stereo cameras, a baseline corresponding to a distance between two lenses of the stereo cameras, and a disparity corresponding to a horizontal displacement between a pair of corresponding pixels on the stereo images.

18. The method of claim 15, wherein the transforming the LiDAR features in the BEV space comprises flattening the LiDAR features along an axis in which the LiDAR features have higher granularity in comparison to LiDAR features along other axes.

19. The method of claim 15, wherein the extracting the camera features from the stereo images comprises using a camera encoder stack including a series of convolutional layers configured to extract different levels of features from the stereo images; or wherein the extracting the LiDAR features from the LiDAR point cloud comprises using a LiDAR encoder stack including a series of convolutional layers configured to extract semantic information of the LiDAR point cloud.

20. The method of claim 15, further comprising decoding the fused camera features and LiDAR features in the BEV space for lane line segmentation, lane marking detection, or three-dimensional object detection.
